(19) United States
(12) Patent Application Publication
(10) Pub. No.: US 2021/0022319 A1
(43) Pub. Date: Jan. 28, 2021

(54) PET CHEW TOY FOR DENTAL SELF-CLEANING BY DOMESTIC PETS

(71) Applicant: Peter Dertsakyan, North Hollywood, CA (US)

(72) Inventor: Peter Dertsakyan, North Hollywood, CA (US)

(21) Appl. No.: 17/034,302

(22) Filed: Sep. 28, 2020

Related U.S. Application Data
(63) Continuation-in-part of application No. 29/709,331, filed on Oct. 14, 2019, now Pat. No. D901104.
Application No. 29/709,331 is a continuation-in-part of application No. 29/663,715, filed on Sep. 18, 2018, now Pat. No. D890454.
Application No. 29/663,715 is a continuation-in-part of application No. 15/472,206, filed on Mar. 28, 2017, now Pat. No. 10,477,838.
Application No. 15/472,206 is a continuation-in-part of application No. 16/600,460, filed on Oct. 12, 2019.
Application No. 16/600,460 is a continuation of application No. 15/472,206, filed on Mar. 28, 2017, now Pat. No. 10,477,838.
(60) Provisional application No. 62/314,353, filed on Mar. 28, 2016.
(60) Provisional application No. 62/314,353, filed on Mar. 28, 2016.

(51) Int. Cl. A01K 15/02; A46B 9/02; A46B 1/00

(52) U.S. Cl. CPC A01K 15/026; A46B 2200/1086; A46B 1/00; A46B 9/026

(57) ABSTRACT

The present invention recognizes that there exists a long felt need to address dental hygiene in pets. A first aspect of the present invention generally relates to a chew toy for pet dental hygiene. A second aspect of the present invention generally relates to a method of promoting pet dental hygiene.

### CROSS REFERENCE TO RELATED APPLICATIONS

The present application is a:

Continuation-in-Part application of U.S. Design patent application Ser. No. 29/709,331, filed Oct. 14, 2019; now pending; which is a

Continuation-in-Part application of U.S. Design patent application Ser. No. 29/663,715, filed Sep. 18, 2018, now U.S. Design Pat. No. D890,454, issued on Jul. 14, 2020; which is a

Continuation-in-Part application of U.S. Utility patent application Ser. No. 15/472,206, filed Mar. 28, 2017, now U.S. Pat. No. 10,477,838, issued on Nov. 19, 2019; which

Claims benefit of priority to U.S. Provisional Application Ser. No. 62/314,353, filed Mar. 28, 2016;

each of which is incorporated by reference herein in its entirety.

The present application is also a:

Continuation-in-Part application of U.S. Utility patent application Ser. No. 16/600,460, filed Oct. 12, 2019, now pending; which is a

Continuation application of U.S. Utility application Ser. No. 15/472,206, filed Mar. 28, 2017, now U.S. Pat. No. 10,477,838, issued on Nov. 19, 2019; which

Claims benefit of priority to U.S. Provisional Application Ser. No. 62/314,353, filed Mar. 28, 2016;

each which is incorporated by reference herein in its entirety.

### TECHNICAL FIELD

The present invention relates generally to the fields of pet chew toys and dental hygiene systems, method of making and using same, and particularly to pet chew toy allowing for the dental self-cleaning by domestic pets.

### BACKGROUND

Maintaining the dental hygiene of domestic pets is a well-known issue. Like humans, domestic pets such as dogs and cats develop bacterial infections, known generally as plaque, on the surface and in the spaces between the teeth of said pets. In addition to the malodorous breath and appearance of domestic pets suffering from an excess of plaque, it can also precipitate the gum disease gingivitis, damage to the pet's teeth, and other material detriment to the oral health of the pet. If left routinely uncleaned, it can harden and become almost impossible to remove without professional assistance.

Traditional methods of cleaning the teeth of pets has involved labor-intensive manual cleaning by the pet owner, a process which is both time-consuming and often results in unnecessary antagonism between the domestic pet and its owner.

Wild relatives of domestic pets, such as wild dogs and wolves, use the frictional effects of gnawing on bones and other hard objects to clean their teeth of plaque and residual pieces of food. The use of domestic pet chew toys as a method of mimicking these natural dental hygiene methods for domestic pets is known in the art. As a consequence, many domestic animal chews or chew toys have been produced of rawhide or other hard surface and configured in such a way as to mimic the shape and feel of natural bone. Other products have introduced additional artificial features to improve upon the natural cleaning action of a domestic pet's chewing action on bone, such as the use of additional projections on a surface of the chew toy.

Information relevant to attempts to address these problems can be found in US Patent Application No. 2004/0216693 to Handelsman; U.S. Pat. No. 6,116,119 to Suchowski; U.S. Pat. No. 6,739,287 to Sarantis; U.S. Pat. D501,961 to Jager; US Patent Application no. 2004/0137118 to Axelrod; and U.S. Pat. Nos. 8,807,088 and 7,490,579 to Axelrod. However, each one of these references suffers from one or more disadvantages. One consistent failing of existing products relates to a domestic pet's propensity to grip or hold an object between its front paws. Domestic pets will naturally seek to stabilize the subject of their chewing action, allowing for a stronger and more satisfying engagement by the pet's mouth, while increasing the friction applied to the pet's teeth and oral cavity by the bone or chew toy. Another failing of existing products is the inability to use pet toothpaste and other supplementary dental hygiene products in conjunction with the chewing action of the chew toys. This leaves the need for supplementary manual cleaning by the domestic pet owner. Yet another disadvantage of existing products is the lack of differentiated surfaces for inner and outer domestic pet teeth. Domestic pets, such as dogs and cats, have substantially different shape and spacing in their teeth between the front of their mouths, wherein are located canines and other long, large teeth, and the smaller, more closely spaced teeth in the back of the pets' mouths. The differences in size and spacing of these teeth suggest the need for different surfaces with different textures and projections adapted to the particular needs of that portion of the domestic pet's dental structures.

For the foregoing reasons, there is a need for an improved domestic pet chew toy that allows domestic pets to clean their own teeth.

### SUMMARY

The present invention recognizes that there exists a long felt need to address dental hygiene in pets.

A first aspect of the present invention generally relates to a chew toy for pet dental hygiene.

A second aspect of the present invention generally relates to a method of promoting pet dental hygiene.

### BRIEF DESCRIPTION OF THE FIGURES

These and other features, aspects, and advantages of the present invention will become better understood with reference to the following description, appended claims, and drawings where:

FIG. 1 shows an embodiment of the invention having a central member with an inner surface defining a cavity, perpendicular stabilizing projections, and a plurality of scrubbing elements on the inner and outer surfaces of the central member.

FIG. 2 shows a side-view of an embodiment of the invention, showing the multiplicity of scrubbing elements projecting from the inner surfaces defining the cavity, and the outer surfaces of the member.

FIG. 3 shows an embodiment of the invention wherein the central member has inner surfaces defining two separate cavities.

FIG. 4 shows a top-down view of the embodiment of FIG. 3, with the positioning for an optional additional reservoir to retain pet toothpaste shown at center.

FIG. 5 shows a lengthwise cut-away of the central member of the embodiment of FIG. 3, demonstrating the shape and positioning of the additional reservoir, and smaller perpendicular holes for dispensing toothpaste retained in said reservoir.

FIG. 6 shows a comparison between different possible sizes of an embodiment of the invention.

FIG. 7 shows a perspective view of a pet toy and dental hygiene device.

FIG. 8 shows a perspective view of a pet toy and dental hygiene device, rotated 90 degrees relative to that show in FIG. 7.

FIG. 9 shows a perspective view of the bottom of a pet toy and dental hygiene device.

FIG. 10 shows a perspective view of the top of a pet toy and dental hygiene device.

FIG. 11 shows a larger perspective view of the top of a pet toy and dental hygiene device relative to FIG. 10.

FIG. 12 shows an orthographic front view of the top of a pet toy and dental hygiene device.

FIG. 13 shows an orthographic side view of the top of a pet toy and dental hygiene device.

FIG. 14 shows an orthographic bottom view of the top of a pet toy and dental hygiene device.

FIG. 15 shows an orthographic top view of the top of a pet toy and dental hygiene device.

FIG. 16 shows a perspective cross section view of a pet toy and dental hygiene device.

FIG. 17 shows a perspective cross section view of a pet toy and dental hygiene device.

FIG. 18 shows an orthographic cross section view of a pet toy and dental hygiene device.

FIG. 19 shows an orthographic cross section view of a pet toy and dental hygiene device.

FIG. 20 shows an orthographic cross section view of a pet toy and dental hygiene device.

FIG. 21 shows an orthographic cross section view of a pet toy and dental hygiene device.

FIG. 22 shows a perspective cross section view of a pet toy and dental hygiene device.

FIG. 23 shows a perspective cross section view of a pet toy and dental hygiene device.

FIG. 24 shows an orthographic cross section view of a pet toy and dental hygiene device.

FIG. 25 shows an orthographic cross section view of a pet toy and dental hygiene device.

FIG. 26 shows an orthographic cross section view of a pet toy and dental hygiene device.

FIG. 27 shows an orthographic cross section view of a pet toy and dental hygiene device.

FIG. 28 shows a perspective cross section view of a pet toy and dental hygiene device.

FIG. 29 shows a perspective cross section view of a pet toy and dental hygiene device.

FIG. 30 shows an orthographic cross section view of a pet toy and dental hygiene device.

FIG. 31 shows an orthographic cross section view of a pet toy and dental hygiene device.

FIG. 32 shows an orthographic cross section view of a pet toy and dental hygiene device.

FIG. 33 shows an orthographic cross section view of a pet toy and dental hygiene device.

FIG. 34 shows the perspective view of FIG. 10, with dashed lines for a portion of a pet toy and dental hygiene device.

FIG. 35 shows the perspective view of FIG. 12, with dashed lines for a portion of a pet toy and dental hygiene device.

FIG. 36 shows the perspective view of FIG. 13, with dashed lines for a portion of a pet toy and dental hygiene device.

FIG. 37 shows the perspective view of FIG. 14, with dashed lines for a portion of a pet toy and dental hygiene device.

FIG. 38 shows the perspective view of FIG. 15, with dashed lines for a portion of a pet toy and dental hygiene device.

FIG. 39 shows the perspective view of FIG. 10, with dashed lines for a portion of a pet toy and dental hygiene device.

FIG. 40 shows the perspective view of FIG. 12, with dashed lines for a portion of a pet toy and dental hygiene device.

FIG. 41 shows the perspective view of FIG. 13, with dashed lines for a portion of a pet toy and dental hygiene device.

FIG. 42 shows the perspective view of FIG. 14, with dashed lines for a portion of a pet toy and dental hygiene device.

FIG. 43 shows the perspective view of FIG. 15, with dashed lines for a portion of a pet toy and dental hygiene device.

FIG. 44 shows perspective views of a pet toy and dental hygiene device in which the cavity for inserting additional features, a space for an insert, and/or reduce the amount of material used in the device is visible in the lower half of a pet toy and dental hygiene device (toward the left-hand side of the page).

FIG. 45 shows perspective views of a pet toy and dental hygiene device in which the cavity for inserting additional features is visible in the lower half of a pet toy and dental hygiene device (toward the left-hand side of the page). In addition, in FIG. 45, the pass-through toothpaste slot that goes all the way through the upper portion of a pet toy and dental hygiene device is visible between the flexible flossing bristles.

FIG. 46 shows perspective views of the reverse side of a pet toy and dental hygiene device from that which is depicted in FIG. 44 and FIG. 45.

FIG. 47 shows perspective views of the reverse side of a pet toy and dental hygiene device from that which is depicted in FIG. 44 and FIG. 45.

FIG. 48 shows a cross-sectional view of a pet toy and dental hygiene device in order to clarify the shape of the pass-through slot, such as but not limited to for toothpaste. The cross-section of this slot as depicted in parallel lines to show the cross section surface is uniform in shape as it passes through a pet toy and dental hygiene device.

FIG. 49 shows a perspective view of a pet toy and dental hygiene device in which the upper surfaces are visible, as well as areas of the large cavity.

FIG. 50 shows a front orthographic view of a pet toy and dental hygiene device. The large cavity for inserts is visible on this side of a pet toy and dental hygiene device.

FIG. 51 shows a rear orthographic view of a pet toy and dental hygiene device, where the pass-through slot, such as but not limited to for toothpaste, is visible in both FIG. 50 and FIG. 51, between the bristles in the upper section of a pet toy and dental hygiene device.

FIG. 52 shows a side orthographic view of a pet toy and dental hygiene device, where one drawing represents both left and right-hand sides of a pet toy and dental hygiene device since they are symmetrical.

FIG. 53 shows a bottom orthographic view of a pet toy and dental hygiene device.

FIG. 54 shows a top orthographic view of a pet toy and dental hygiene device.

The broken lines shown in the drawings are for illustrative purposes only and form no part of the claimed design.

The parallel lines shown in the drawings depict sectioned surfaces.

The sectioned surfaces show structures or spaces that are visible from the outside of the design, such as but not limited to a toothpaste reservoir or a pass-through toothpaste slot.

### DETAILED DESCRIPTION OF THE INVENTION

### Definitions

Unless defined otherwise, all technical and scientific terms used herein have the same meaning as commonly understood by one of ordinary skill in the art to which this invention belongs. Where a term is provided in the singular, the inventors also contemplate the plural of that term. The nomenclature used herein and the laboratory procedures described below are those well-known and commonly employed in the art. As employed throughout the disclosure, the following terms, unless otherwise indicated, shall be understood to have the following meanings:

“Directly” refers to direct causation of a process that does not require intermediate steps.

“Indirectly” refers to indirect causation that requires intermediate steps.

The term “comprises” and grammatical equivalents thereof are used herein to mean that other components, ingredients, steps, etc. are optionally present. For example, an article “comprising” (or “which comprises”) components A, B, and C can consist of (for example, contain only) components A, B, and C, or can contain not only components A, B, and C but also one or more other components.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose lower limit is the first number and whose upper limit is the second number. For example, 25 to 100 mm means a range whose lower limit is 25 mm, and whose upper limit is 100 mm.

Other technical terms used herein have their ordinary meaning in the art that they are used, as exemplified by a variety of technical dictionaries.

In the Summary and in the Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

### INTRODUCTION

The present invention recognizes that there exists a long felt need to address dental hygiene in pets.

As a non-limiting introduction to the breath of the present invention, the present invention includes several general and useful aspects, including:

1) a chew toy for pet dental hygiene; and

2) a method of promoting pet dental hygiene.

These aspects of the invention, as well as others described herein, can be achieved by using the methods, articles of manufacture and compositions of matter described herein. To gain a full appreciation of the scope of the present invention, it will be further recognized that various aspects of the present invention can be combined to make desirable embodiments of the invention.

### I A Chew Toy for Pet Dental Hygiene

The present invention includes a chew toy for pet dental hygiene.

A first aspect of the present invention includes: a chew toy for pet dental hygiene, including: a) at least one chewing member, including: i) at least one groove running in a longitudinal direction of the at least one chewing member that includes a plurality of protruding scrubbing elements; and ii) a plurality of nub shaped elements positioned on an outside surface of the chewing member; and b) at least one bottom stabilizing portion; i) wherein the at least one bottom stabilizing portion located at a bottom end of the at least one chewing member and being in a perpendicular plane with respect to the at least one chewing member includes at least one projection that stabilizes the chew toy when in use.

A. Chewing Member

The chewing member can be the length of the device, substantially the length of the device, a portion of the length of the device, or a combination thereof. Preferred sizes are between about 10 mm and about 1,000 mm, and more preferred between about 50 mm and about 500 mm, and more preferably between about 100 mm and about 500 mm in length, and more preferably between about 100 mm and about 200 mm. The shape can be any as appropriate, such as cones, cylinders, semi-circles, half circles, squares, ovals, geometric shapes, non-geometric shapes, and the like, and a combination thereof. The chewing member has a variety of elements that tend to define the chewing member, and the chewing member is of a general shape with those additional elements (such as but not limited to grooves and protrusions and the like as set forth herein and otherwise available).

B. Groove

Another aspect of the present invention includes wherein the at least one groove is generally U-shaped.

The generally U-shaped groove can be the length of the device, substantially the length of the device, the length of the chewing member or a portion thereof, the length of the bottom stabilizing portion or a portion thereof, or a combination thereof.

A further aspect of the present invention includes wherein at least one of the at least one groove includes, on at least a portion of all internal surfaces of the at least one groove, a plurality of protruding scrubbing elements.

An additional aspect of the present invention includes wherein when there are two or more grooves, the two or more grooves are arranged parallel to each other.

Another aspect of the present invention includes wherein the at least one groove is perpendicular to an at least one bottom stabilizing portion.

A further aspect of the present invention includes wherein the at least one groove is substantially the length of the chewing member.

An additional aspect of the present invention includes wherein when there are two or more grooves, the two or more grooves are positioned on opposing sides of the chewing member.

Another aspect of the present invention includes wherein each of the at least one grooves is generally U-shaped in cross section across the chewing member.

A further aspect of the present invention includes wherein the at least one groove generally defines the at least one chewing member with a first and second end.

An additional aspect of the present invention includes wherein the at least one groove is sufficiently deep to clean teeth to the gum line.

C. Protruding Scrubbing Elements

Another aspect of the present invention includes wherein the protruding scrubbing elements includes bristles.

The protruding scrubbing elements can be of any appropriate size and shape, and distribution pattern (such as like dimples on a golf ball, as a rough analogy). Preferred sizes are between about 1 mm and about 100 mm, and more preferred between about 5 mm and about 50 mm, and more preferably between about 5 mm and about 10 mm in length. The shape can be any as appropriate, such as cones, cylinders, semi-circles, half circles, squares, ovals, scraping shapes (such as but not limited to windshield wiper shapes, squeegee shapes, the like, and combinations thereof), rounded edges, sharp edges, rounded ends, sharp ends, geometric shapes, non-geometric shapes, and the like, and a combination thereof.

D. Nub Shaped Elements

A further aspect of the present invention includes wherein the nub shaped elements are larger or smaller in diameter than the protruding scrubbing elements, longer or shorter in length than the protruding scrubbing elements, or a combination thereof.

The nub shaped elements can be of any appropriate size and shape, and distribution pattern (such as like dimples on a golf ball, as a rough analogy, though dimples would be inversion of nub shaped elements). Preferred sizes are between about 1 mm and about 100 mm, and more preferred between about 5 mm and about 50 mm, and more preferably between about 5 mm and about 10 mm in length. The shape can be any as appropriate, such as cones, cylinders, semi-circles, half circles, squares, ovals, scraping shapes (such as but not limited to windshield wiper shapes, squeegee shapes, the like, and combinations thereof), rounded edges, sharp edges, rounded ends, sharp ends, geometric shapes, non-geometric shapes, and the like, and a combination thereof.

An additional aspect of the present invention includes wherein the chew toy does not include such nub shaped elements

E. Aperture

An additional aspect of the present invention further includes at least one aperture.

The aperture can be of any size and shape, such as but not limited to a circle, semi-circle, square, rectangle, rounded corners and edges, angles corners and edges, the like, and a combination thereof. Preferred sizes include but are not limited to between about 1 mm and about 100 mm in diameter or length, between about 5 mm and about 50 mm, and between about 5 mm and about 10 mm.

A further aspect of the present invention includes wherein the at least one aperture is present in a first end of the chewing member.

The first end of the chewing member is the portion most distal to the bottom stabilizing portion of the device. The second end of the chewing member is the portion most proximal to the bottom stabilizing member.

Another aspect of the present invention includes wherein the at least one aperture is present central to the first end of the at least one chewing member.

The aperture need not be centrally placed though, and can be off center, and can be placed anywhere as appropriate.

F. Cavity

A further aspect of the present invention further includes at least one cavity within the chewing member.

The cavity can be of any appropriate shape and size. The presence of such at least one cavity is optional. Preferred shapes include but are not limited to cylindrical, square, rectangular, geometrically shaped, non-geometrically shaped, and a combination thereof. Preferred sizes include but are not limited to between about 1 mm and about 100 mm in diameter or length, between about 5 mm and about 50 mm, and between about 5 mm and about 10 mm.

An additional aspect of the present invention includes wherein the at least one cavity is longitudinal as to the at least one chewing member.

Another aspect of the present invention includes wherein the at least one cavity begins at an aperture in the first end of the chewing member and runs at least a portion of the length of the chewing member.

A further aspect of the present invention includes wherein the at least one longitudinal cavity is configured to hold at least one substance.

An additional aspect of the present invention includes wherein the substance includes toothpaste.

Other substance beside toothpaste can be included, such as but not limited to food or treats, such as but not limited to liquids, pastes, and solids. Examples include prepared materials, peanut butter, solid and semi-solid, and chewy materials that are food or treat for domestic animals. The substance can include a medicament as well, but that need not be the case.

G. Dispensing Hole

Another aspect of the present invention further includes at least one dispensing hole.

The dispensing can be of any appropriate shape and size. Preferred shapes include but are not limited to cylindrical, square, rectangular, geometrically shaped, non-geometrically shaped, and a combination thereof. Preferred sizes include but are not limited to between about 1 mm and about 100 mm in diameter or length, between about 5 mm and about 50 mm, and between about 5 mm and about 10 mm.

A further aspect of the present invention includes wherein the at least one dispending hole communicates between at least one cavity and the at least one groove.

An additional aspect of the present invention includes wherein the at least one dispensing hole is perpendicular to the at least one cavity.

Another aspect of the present invention includes wherein the at least one dispensing hole is adapted to transfer at least one substance between the at least one longitudinal cavity and the at least two U-shaped grooves.

A further aspect of the present invention includes wherein the substance includes toothpaste.

Other substance beside toothpaste can be included, such as but not limited to food or treats, such as but not limited to liquids, pastes, and solids. Examples include prepared materials, peanut butter, solid and semi-solid, and chewy materials that are food or treat for domestic animals. The substance can include a medicament as well, but that need not be the case

H. Bottom Stabilizing Portion

An additional aspect of the present invention includes wherein the at least one projection is substantially flat.

The bottom stabilizing portion can be the length of the device, substantially the length of the device, a portion of the length of the device, or a combination thereof. Preferred sizes are between about 10 mm and about 1,000 mm, and more preferred between about 50 mm and about 500 mm, and more preferably between about 100 mm and about 500 mm in length, and more preferably between about 100 mm and about 200 mm. The shape can be any as appropriate, such as cones, cylinders, semi-circles, half circles, squares, ovals, geometric shapes, non-geometric shapes, and the like, and a combination thereof.

Another aspect of the present invention includes wherein the at least one projection is perpendicular to the chewing member.

A further aspect of the present invention includes wherein the at least one bottom stabilizing portion is configured to stabilize the chew toy in an upright position.

I. Gripping Elements

An additional aspect of the present invention includes wherein the bottom stabilizing portion further includes one or more gripping elements.

The gripping elements can be of any appropriate size and shape, and distribution pattern (such as like dimples on a golf ball, as a rough analogy, though dimples would be inversion of nub shaped elements). Preferred sizes are between about 1 mm and about 100 mm, and more preferred between about 5 mm and about 50 mm, and more preferably between about 5 mm and about 10 mm in length. The shape can be any as appropriate, such as cones, cylinders, semi-circles, half circles, squares, ovals, scraping shapes (such as but not limited to windshield wiper shapes, squeegee shapes, the like, and combinations thereof), rounded edges, sharp edges, rounded ends, sharp ends, geometric shapes, non-geometric shapes, and the like, and a combination thereof.

An additional aspect of the present invention includes wherein the chew toy does not include such gripping elements.

J. Materials

An additional aspect of the present invention includes wherein the chew toy includes a single structure.

Another aspect of the present invention includes wherein the chew toy includes a unitary structure.

A further aspect of the present invention includes wherein the chew toy includes more than one component.

An additional aspect of the present invention includes wherein the chew toy includes non-toxic material.

Another aspect of the present invention includes wherein the chew toy includes a single material.

A further aspect of the present invention includes wherein the chew toy includes multiple materials.

The multiple materials can be, for example, a combination of materials, or an assembly of components of different materials, the like, or a combination thereof.

An additional aspect of the present invention includes wherein the chew toy includes two or more separate portions.

Another aspect of the present invention includes wherein the two or more separate portions that can be assembled together.

A further aspect of the present invention includes wherein the chew toy includes at least one plastic, at least one rubber, at least one natural rubber, at least one synthetic rubber, at least one thermoplastic elastomer, at least one thermoplastic resin, at least one nylon material, an inedible material, an edible material, or a combination thereof. Components such as nub shaped elements or protruding scrubbing elements can be of the same or different material that the rest of the device is made of, and individual components such as individual nub shaped elements or protruding scrubbing elements can be the same or different materials as other nubs or bristles.

The edible materials can be any as appropriate, such as but not limited to those for non-toxic treats and such, such as but not limited to Nylabones and Greenies.

The inedible material can be any as appropriate, such as but not limited to those for non-toxic toys and such, such as but not limited to plastic, rubber, natural rubber, synthetic rubber, thermoplastic elastomer, thermoplastic resin, nylon material.

K. Insert Space and Insert

An additional aspect of the present invention further includes at least one space for at least one insert, and the insert as well.

The insert and the insert space can be the length of the device, substantially the length of the device, a portion of the length of the device, or a combination thereof. Preferred sizes are between about 10 mm and about 1,000 mm, and more preferred between about 50 mm and about 500 mm, and more preferably between about 100 mm and about 500 mm in length, and more preferably between about 100 mm and about 200 mm. The shape can be any as appropriate, such as cones, cylinders, semi-circles, half circles, squares, ovals, geometric shapes, non-geometric shapes, and the like, and a combination thereof. The size and shape of the insert can be determined by the size and shape of the element in which the insert and the insert space is located.

Another aspect of the present invention includes wherein the at least one space is located below the chewing member, within the chewing member, or a combination thereof.

A further aspect of the present invention further includes at least one insert.

The insert can be any as appropriate, such as but not limited to treats, attractants, toothpaste, dried down toothpaste to have a more viscous consistency, dentifrice materials to treat teeth such as ethanol, neem oil, and the like and combinations thereof. Also, therapeutic materials such as pharmaceuticals, drugs, remedies, CBD, the like, and combinations thereof, so that the device can act as a drug delivery device as well. The insert can be pre formed as a drop in without an additional structure such as a cup, or provided with such a cup structure, the like or a combination thereof.

An additional aspect of the present invention includes wherein the at least one insert is operably engaged with the at least one space.

Another aspect of the present invention includes wherein the at least one insert includes at least one flossing structure, at least one tongue cleaning structure, at least one treat holding structure, at least one extra brushing element structure, at least one toothpaste holding structure, at least one breath freshening compound, at least one fluid dispensing structure, at least one liquid dispensing structure, at least one sponge or sponge like structure, or a combination thereof.

L. Without Bottom Stabilizing Portion

A further aspect of the present invention includes wherein the chew toy does not include the at least one bottom stabilizing portion.

M. Pet

An additional aspect of the present invention includes wherein the pet includes a dog.

Another aspect of the present invention includes wherein the chew toy is operable as a toothbrush for use by pets to brush their own teeth.

A further aspect of the present invention includes wherein when the chew toy is in use, multiple teeth and multiple surfaces of teeth are cleaned.

### II A Method of Promoting Pet Dental Hygiene

The present invention also includes a method of promoting pet dental hygiene.

A second aspect of the present invention includes: a method of promoting pet dental hygiene, including: a) providing a pet in need of promotion of dental hygiene; b) providing a chew toy of the present invention; c) allowing the pet to engage with the chew toy; and d) wherein the dental hygiene of the pet is promoted.

A further aspect of the present invention includes wherein the chew toy includes toothpaste.

An additional aspect of the present invention includes wherein the pet includes a dog.

Another aspect of the present invention includes wherein at least one of the at least two grooves are sufficiently deep to clean teeth to the gum line.

A further aspect of the present invention includes wherein when the chew toy is in use, multiple teeth and multiple surfaces of teeth are cleaned.

### EXAMPLES

### Example 1: A Pet Chew Toy for Dental Self-Cleaning, “Tower” Configuration

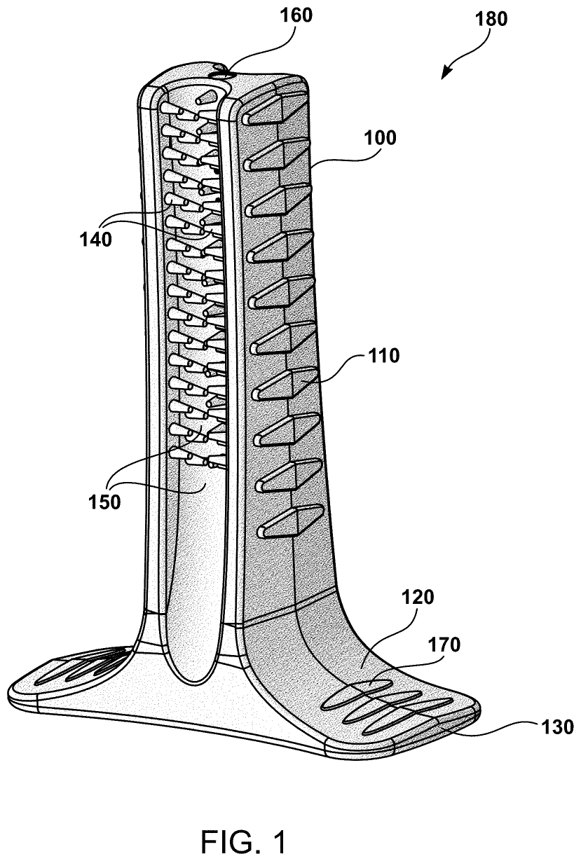

This example establishes working examples for a pet chew toy for dental self-cleaning of the present invention, generally being a “tower” configuration, as exemplified by FIG. 1 through FIG. 6. Element numbers are as follows for this example and the referenced figures: Chewing Member (100), Nub Shaped Element (110), Bottom Stabilizing Portion (120), Projection (130), Protruding Scrubbing Element (140), Groove (150), Aperture (160), Gripping Element (170), the Device in its Entirety (180), with three different sizes of large (182) and medium (184) and small (186), Internal Space to reduce material uses (190) Cavity (500), and Dispensing Hole (510).

One possible embodiment of the invention takes the form of a chew toy for use by a domestic pet such as a dog, cat or other domesticated animal. This embodiment comprises a central member for engagement of a domestic pet's oral cavity, which includes at least one inner surface defining a cavity and an outer surface, each or both of which may have a variety of scrubbing elements affixed to them.

Another possible embodiment comprises a central member for engagement of a domestic pet's oral cavity, said member having a first end and a second end. The second end further comprises one or more projections, which may be circular or otherwise shaped, which are substantially flat and oriented perpendicular to the length of the central member. The projections allow the member to be stood upright and gripped by a domestic pet, using its front paws.

Yet another possible embodiment includes a reservoir running the length of the central member of a chew toy, in which, by way of non-limiting example, flavored toothpaste for domestic pets can be retained. Smaller dispensing holes are present in the central member perpendicular to the reservoir, allowing the toothpaste or other products to be dispensed into the oral cavity of a domestic pet when the central member is engaged by said pet's oral cavity.

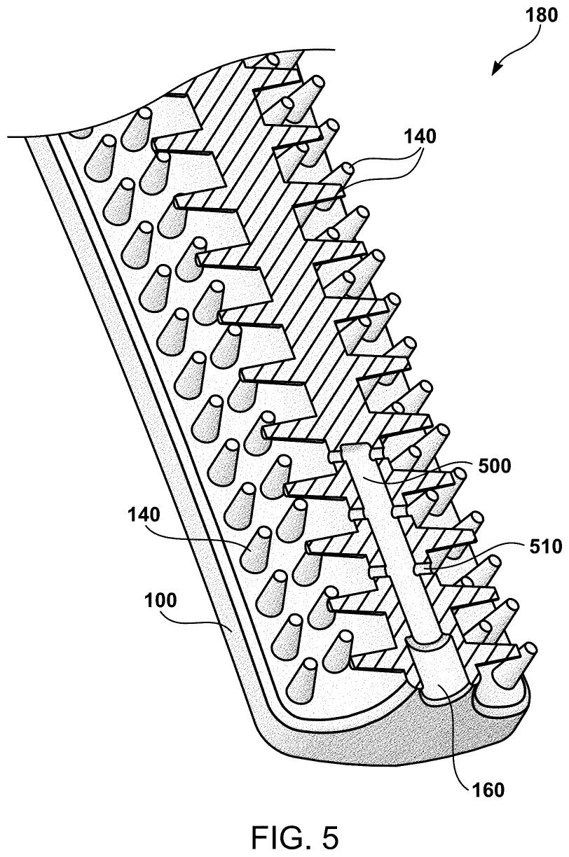

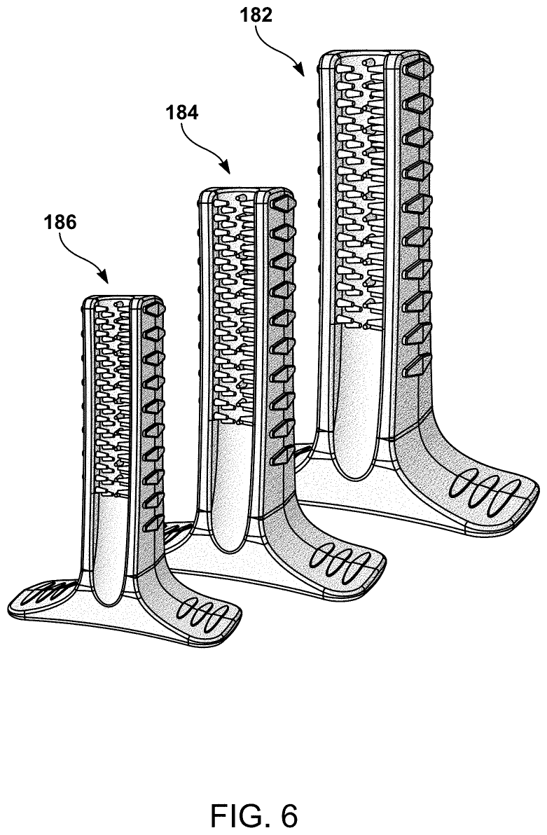

In one possible embodiment of the invention, as shown in FIG. 1, takes the form of a chew toy having a central member. The chew toy may be made of any suitable material, including by way of non-limiting example any non-toxic plastic. The central member comprises at least one inner surface, defining a cavity having an open end running the length of the central member and an additional open side at the top end of the central member. Said cavity should be of sufficient depth to allow full penetration by the front or back teeth of a domestic pet. The size of the central member, and therefore relative depth of the cavity, may be varied to suit a variety of domestic pet breeds, as shown in FIG. 6. By providing inner and outer surfaces for contact with the teeth and gums of a domestic pet, faster and more complete cleaning action is achieved on the pet's teeth and gums by maximizing the area of contact and friction between the central member and the pet's teeth and gums. A cross section of an upper section of the top portion of the device is shown in FIG. 5, showing through holes and reservoirs, as well as other aspects of the present invention, in greater detail. In addition, further cleaning action is achieved by the simultaneous contact of the surfaces of the member with the forward and inner teeth of the pet.

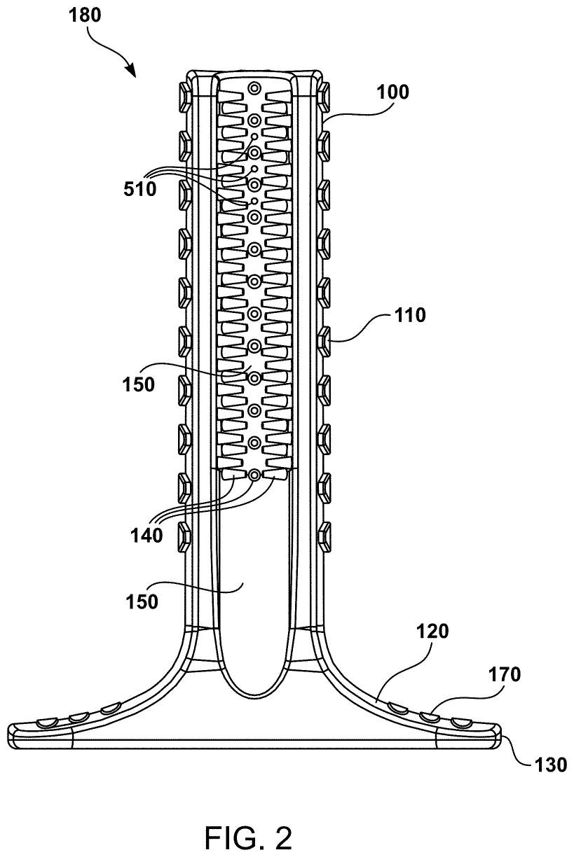

As shown in FIG. 2, the outer surface of the central body may have affixed to it a plurality of scrubbing elements. As also show in FIG. 2, the inner surface defining the cavity may also have affixed to it an additional plurality of scrubbing elements.

The scrubbing elements affixed to the outer and inner surfaces may vary in size and shape. By way of example, they could take the form of bristles, pyramids, cones, rectangles, or any of a variety of other desirable configurations. The scrubbing elements affixed to the outer surface of the central member might, in one possible embodiment, be of a different shape or size than the scrubbing elements affixed to the inner surface, as shown in FIG. 2. Similarly, the size and shape of the scrubbing elements affixed to the inner surface might be the same as those affixed to the outer surface of the central member. This allows the scrubbing elements to be adapted to the differential spacing, tooth shape, and mouth size of a variety of domestic pets.

A further aspect of the present invention is shown in FIG. 1, comprising the substantially flat perpendicular projections. Although the embodiment shown in FIG. 1 has the projections take the form of two flanges or separate extensions, one of skill in the art will understand that the projection or projections can take a variety of shapes and sizes. Non-limiting examples might be a singular projection forming a circular base to the central member, or a multiplicity of flanges allowing a pet to grip the projections from a variety of angles. These projections allow a pet to fully stabilize the chew toy upright using their natural gripping action with the front paws.

In contrast to the rough or knobbed ends of natural bones or typical pet chew toys, here the domestic pet can fully pin down and stabilize the central member of the chew toy such that it is fully upright and immobile. This allows for a much strong grip on the central body by the mouth of the domestic pet, increasing the friction between the surface of the chew toy and the pet's teeth. This allows for superior cleaning and removal of plaque, leftover food, and other detrimental material from the mouth of the pet.

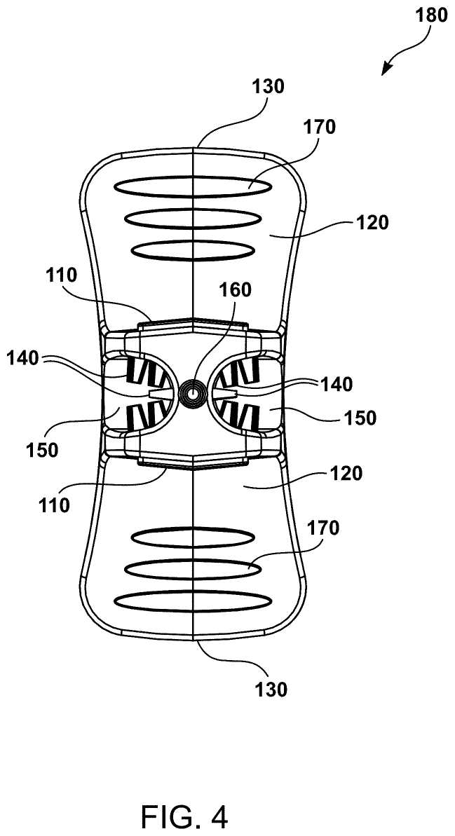

Yet a further aspect of the present invention is shown in FIG. 4, showing one possible embodiment of the central reservoir for toothpaste or other substances suitable for dispensing. Here, the opening allows for input of a pet toothpaste or other appropriate substance into the reservoir, which is dispensed through perpendicular holes to the main cavity or cavities of the chew toy. Although in this particular embodiment the reservoir takes a cylindrical form, other embodiments might include one or more reservoirs of different shapes or locations.

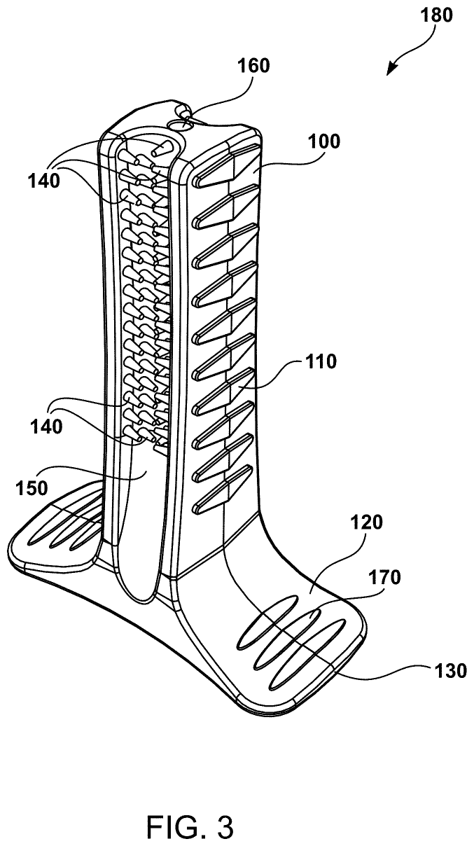

Another possible embodiment of the present invention is shown in FIG. 3. Here, the central member comprises two inner surfaces, each defining separate cavities similar to the single cavity shown in FIG. 1. By providing a second cavity, a domestic pet can simultaneously engage not just the forward and rear of the pet's teeth and gums simultaneously, but on the top and bottom of the pet's mouth as well.

### Example 2: A Pet Chew Toy for Dental Self-Cleaning, “Rounded” Configuration

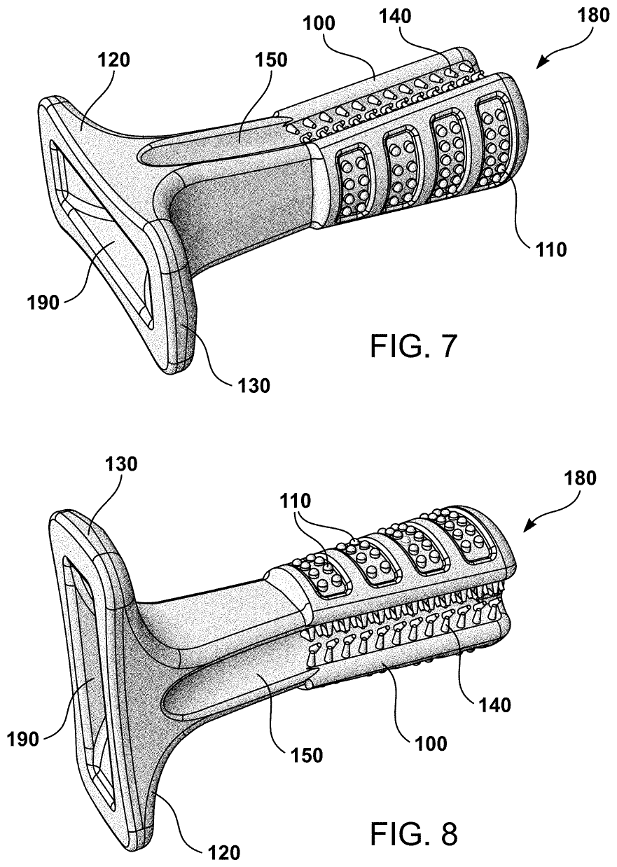

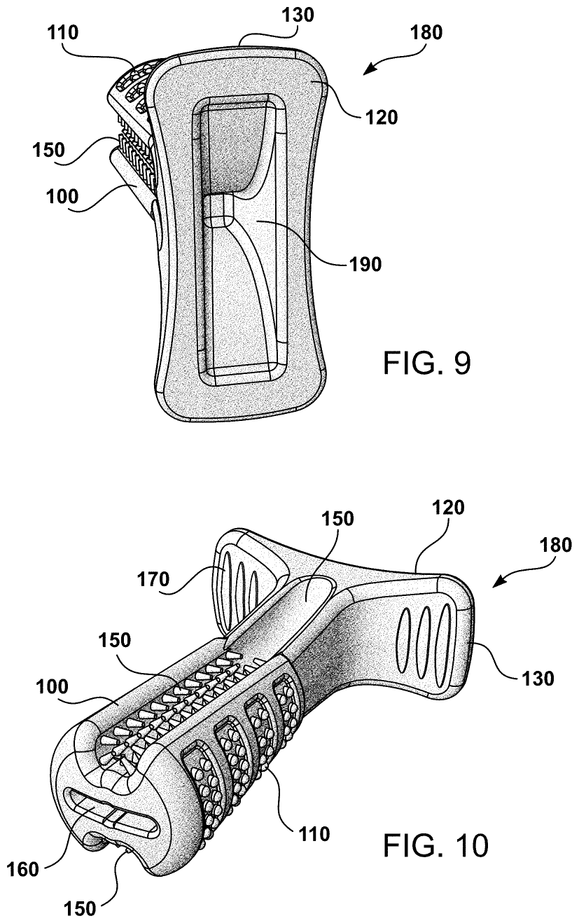

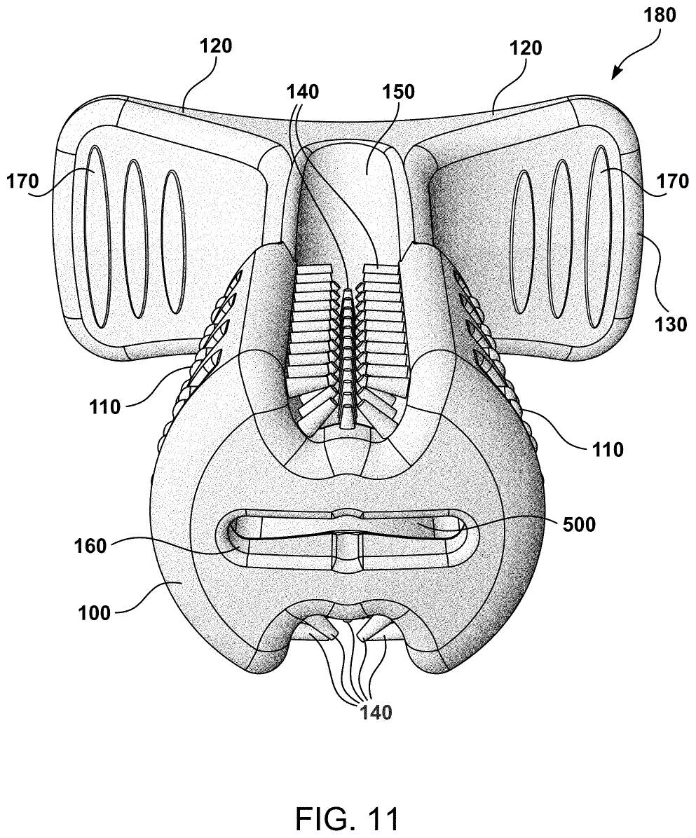

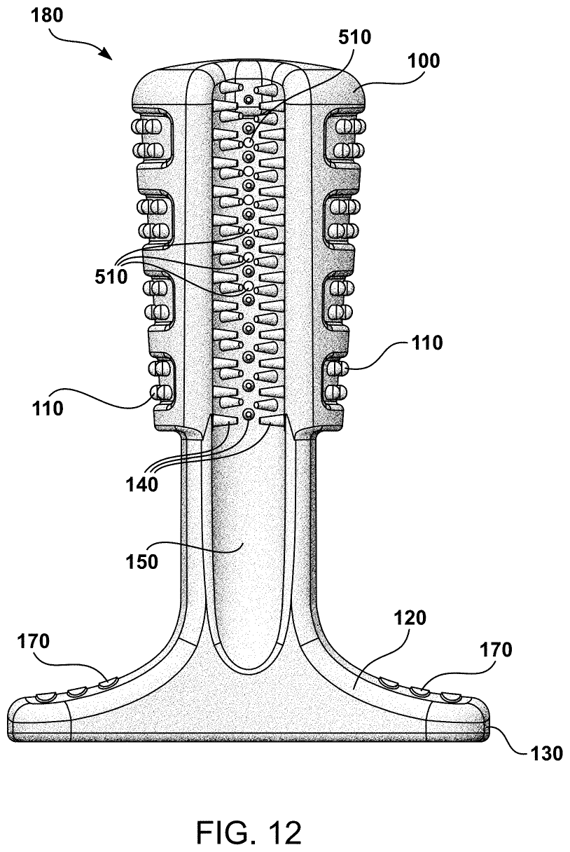

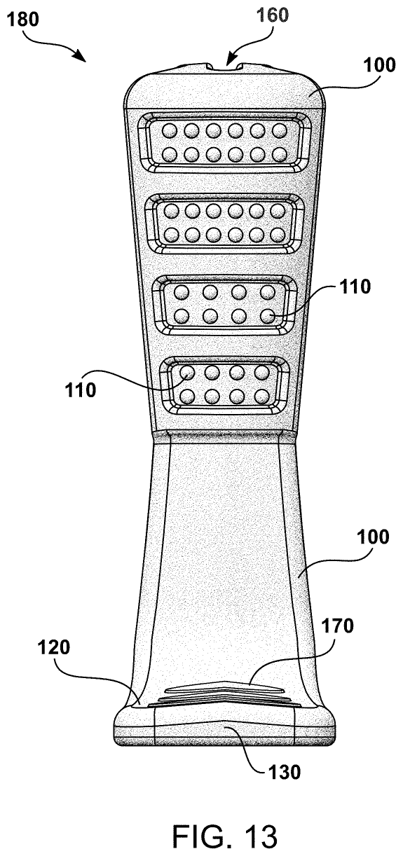

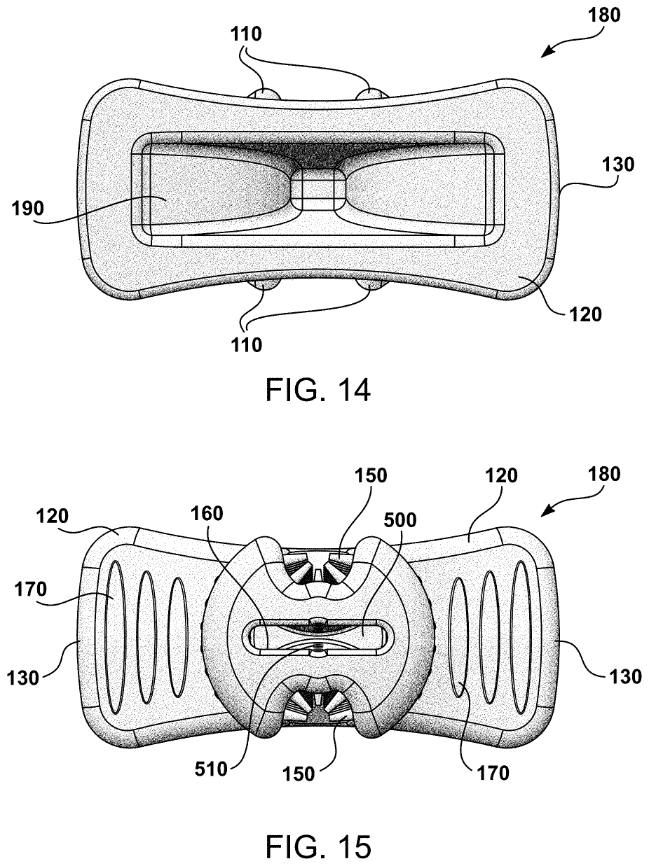

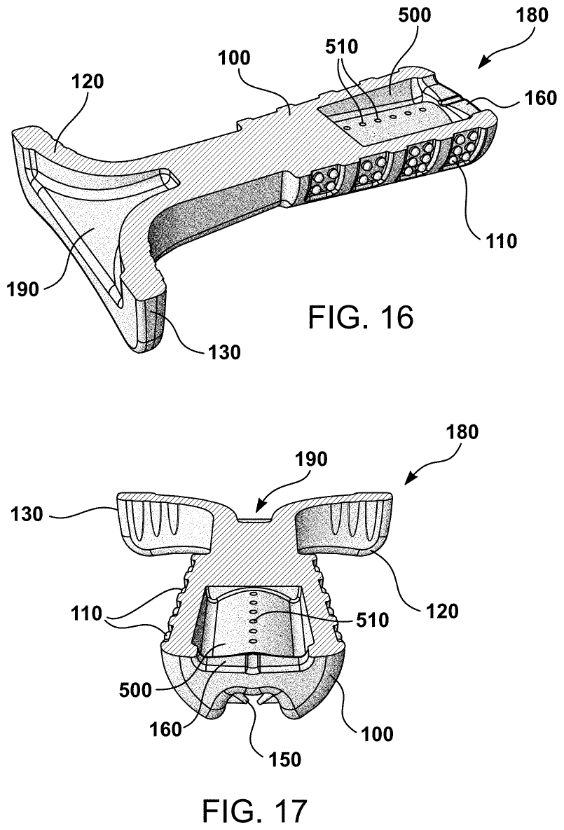

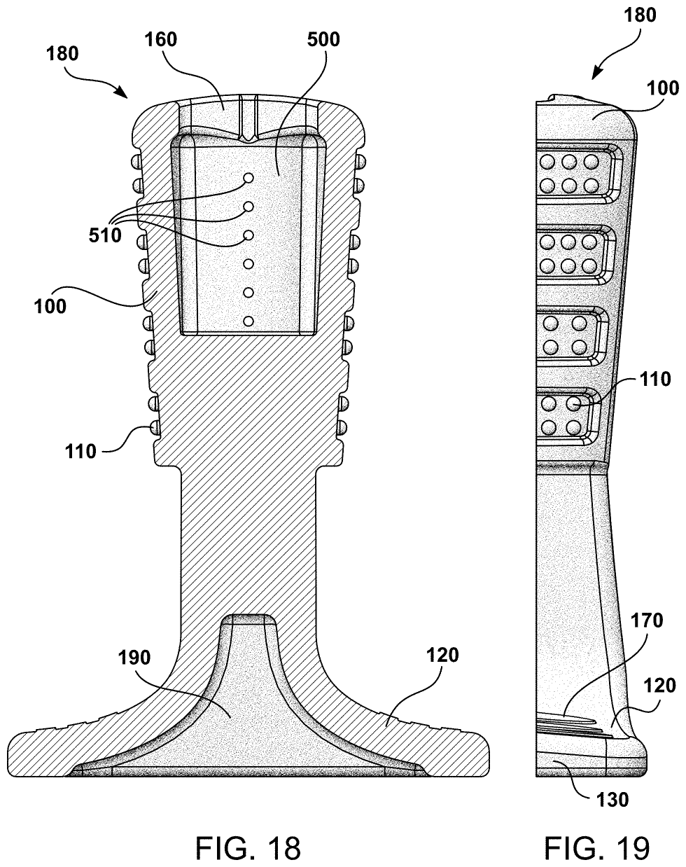

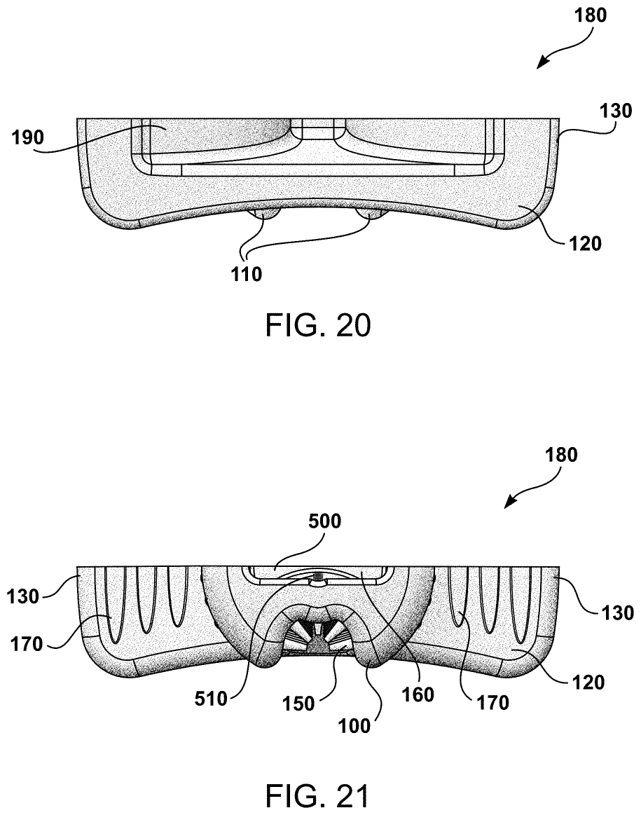

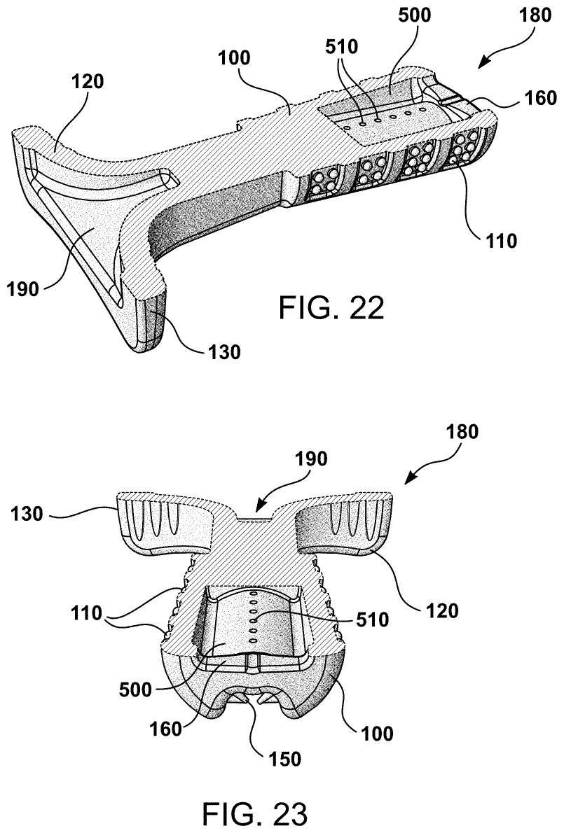

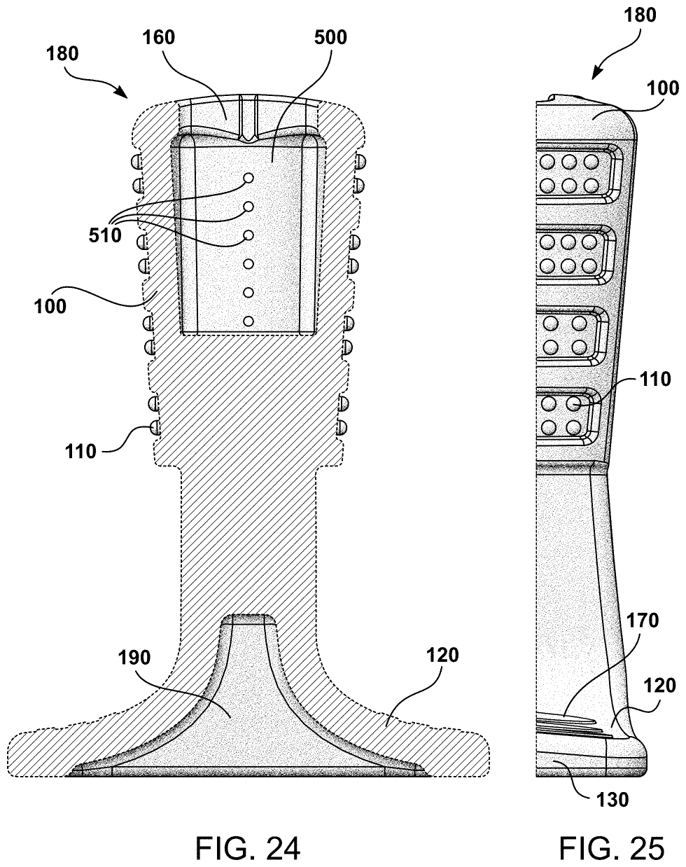

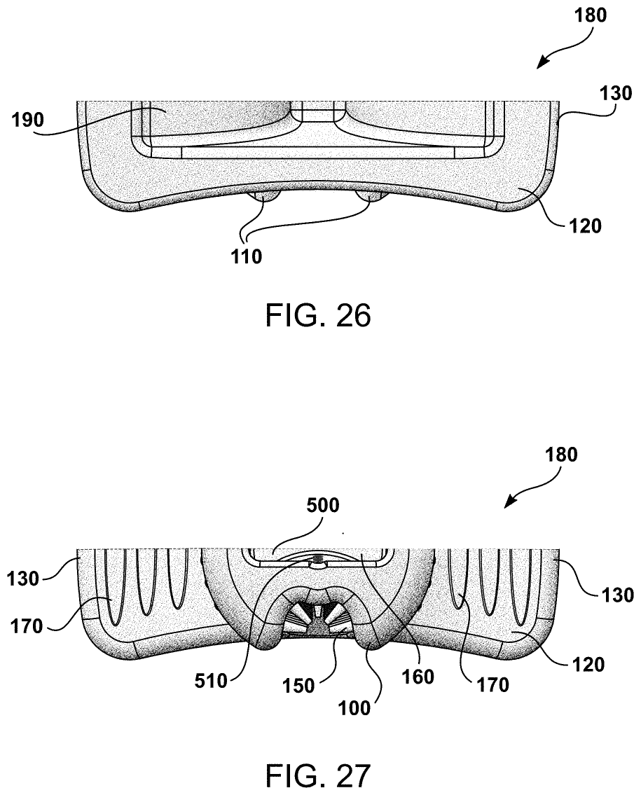

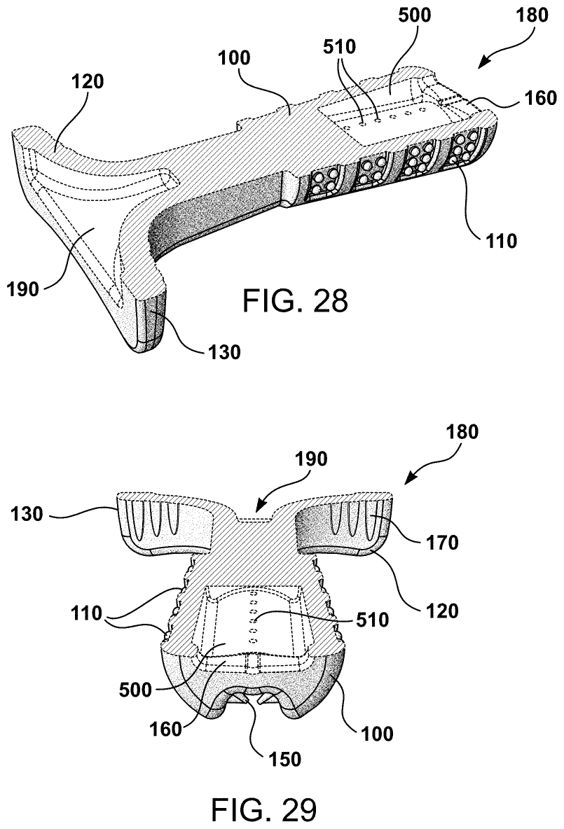

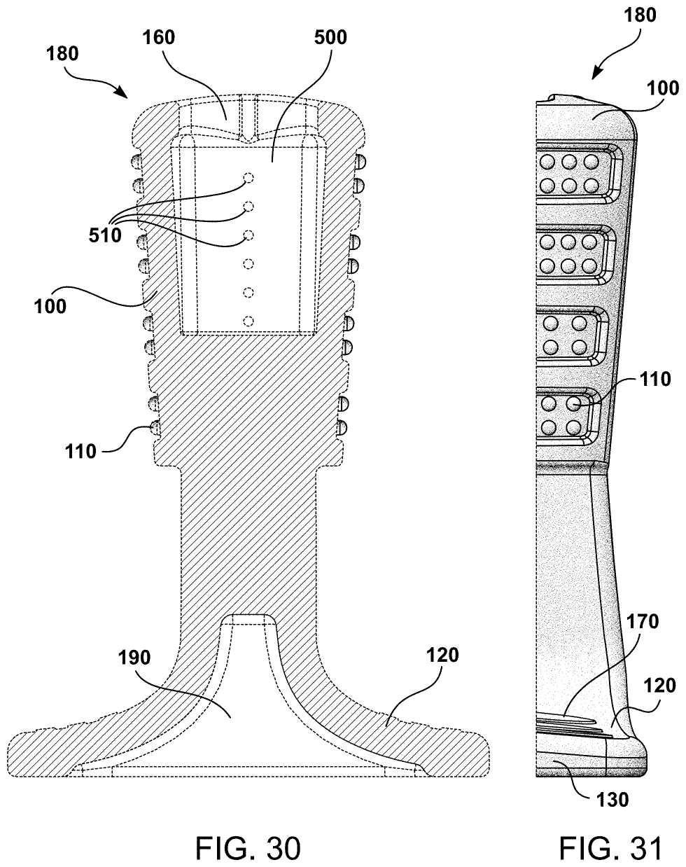

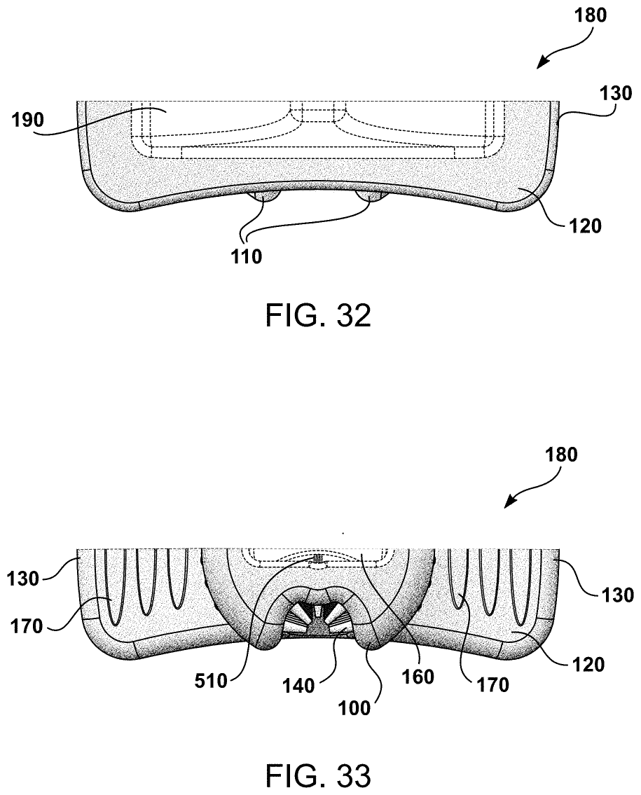

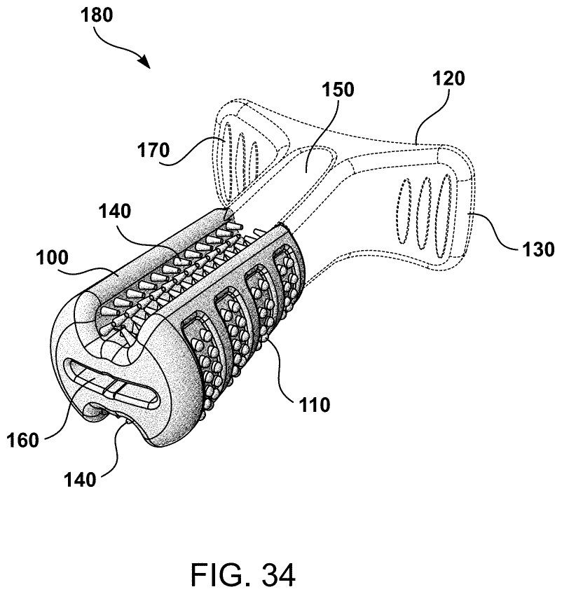

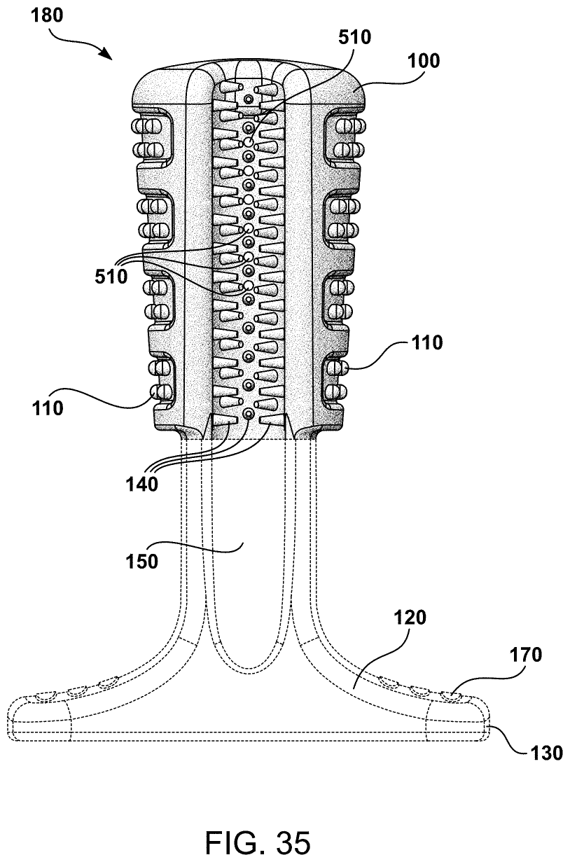

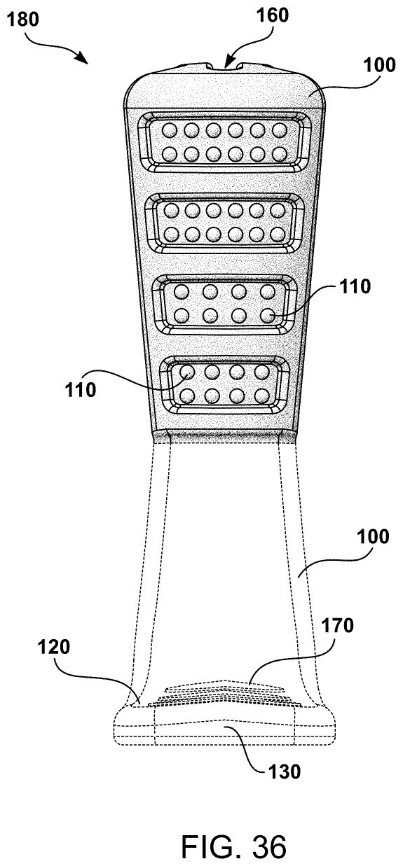

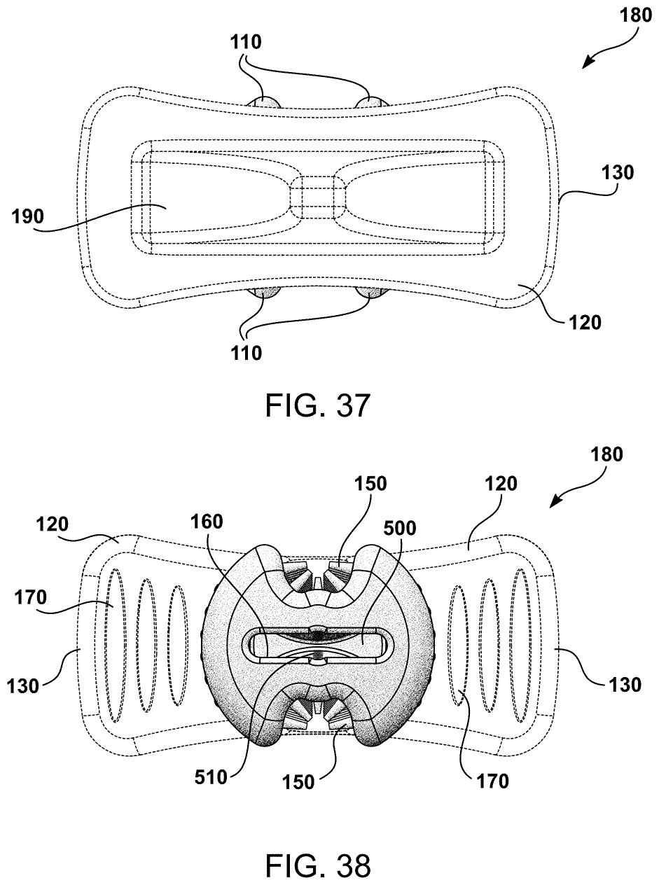

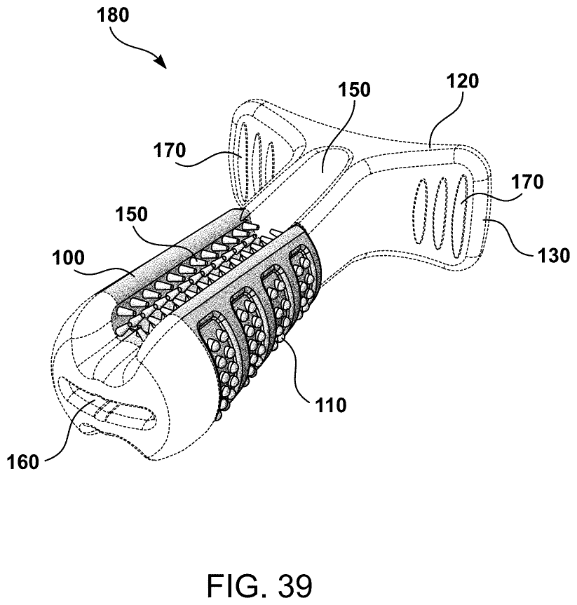

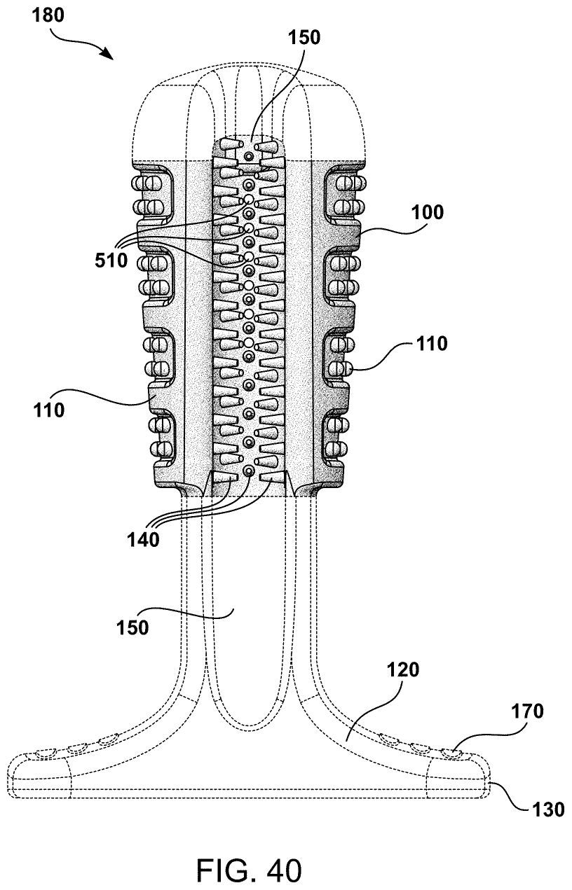

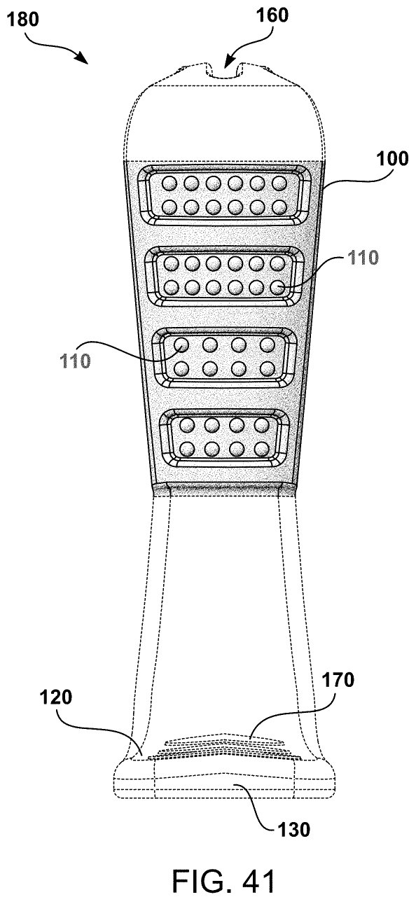

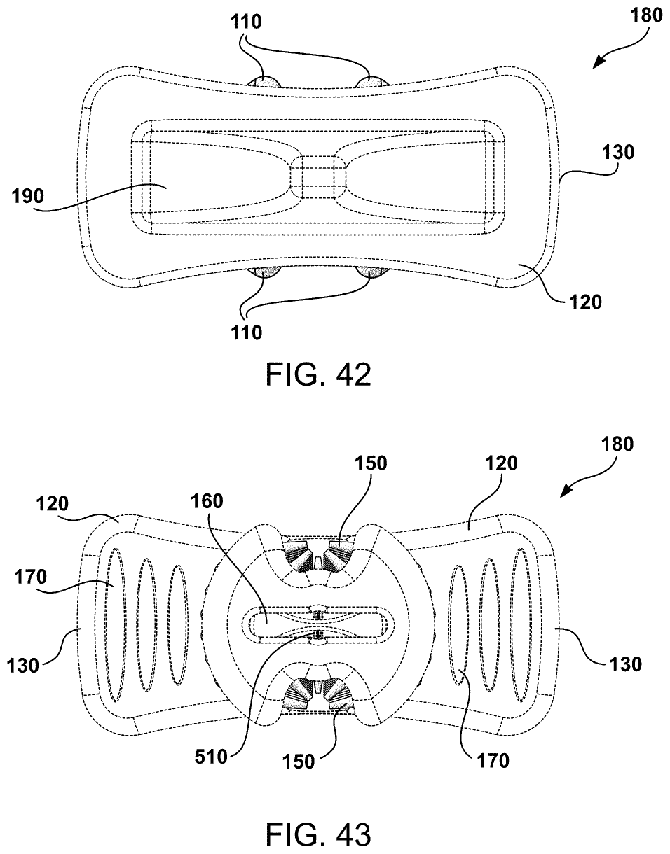

This example establishes working examples for a pet chew toy for dental self-cleaning of the present invention, generally being in a “rounded” configuration, as exemplified by FIG. 7 through FIG. 43.

As set forth in FIG. 7 through FIG. 43, in this aspect of the present invention the device of FIG. 1 through FIG. 6 has been modified so as to have a more rounded Chewing Member (100) with modified Nub Shaped Elements (110), Bottom Stabilizing Portion (120), Projection (120), Protruding Scrubbing Elements (140), Grooves (150), Aperture (160), Gripping Elements (170), and the Internal Space to reduce materials use (190), Internal Cavity (500), and Dispensing Holes (510).

### Example 3: A Pet Chew Toy for Dental Self-Cleaning, “Insert” Configuration

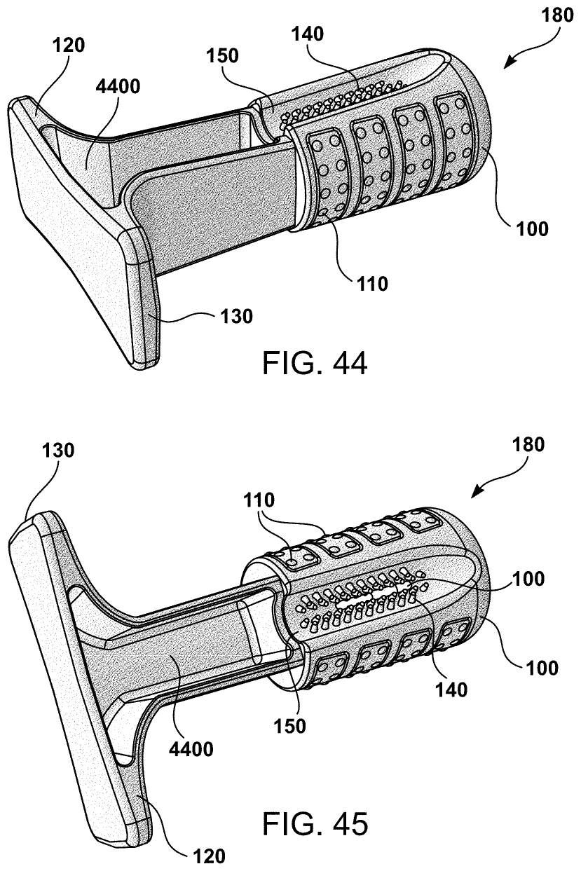

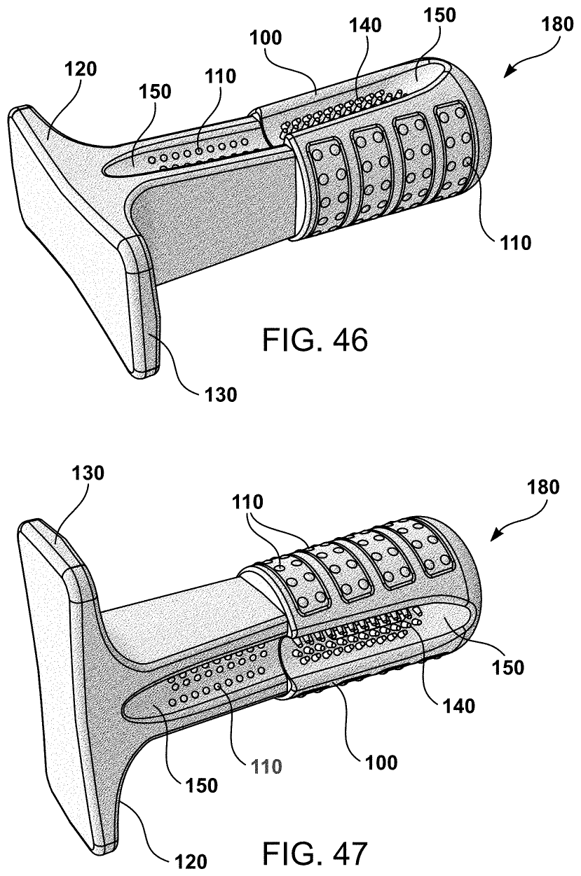

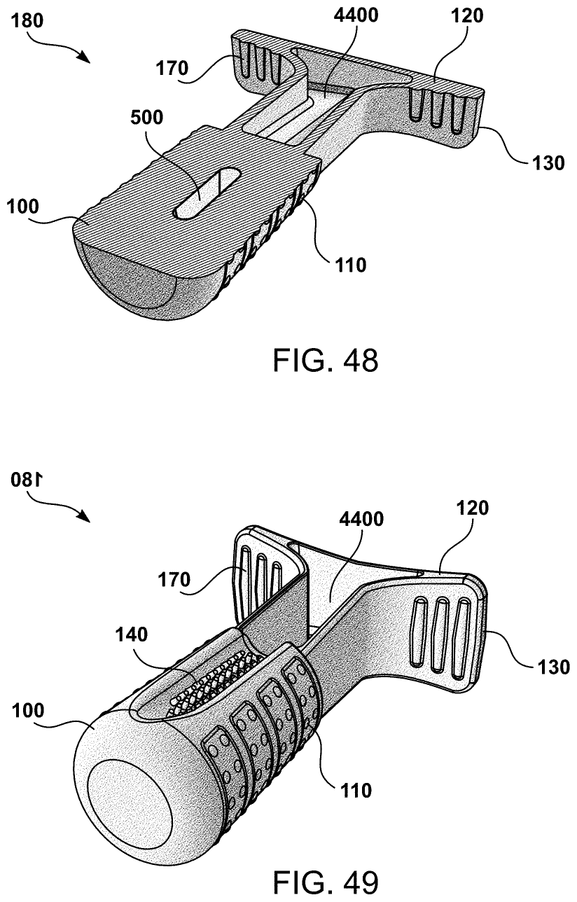

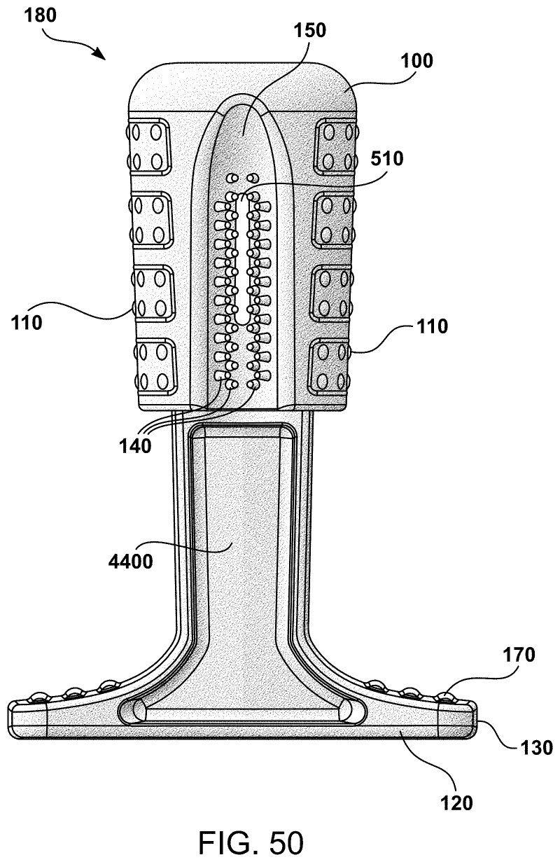

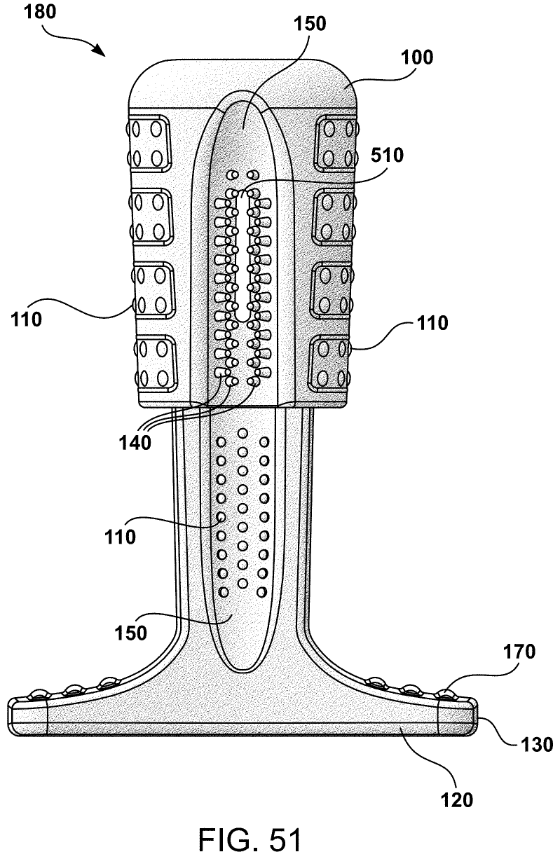

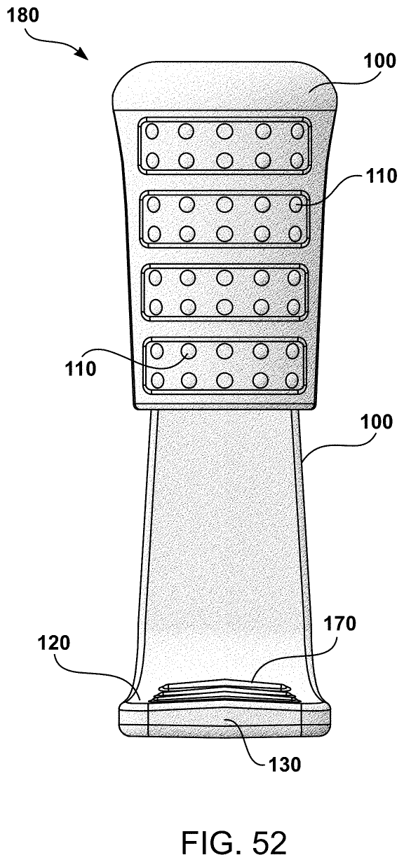

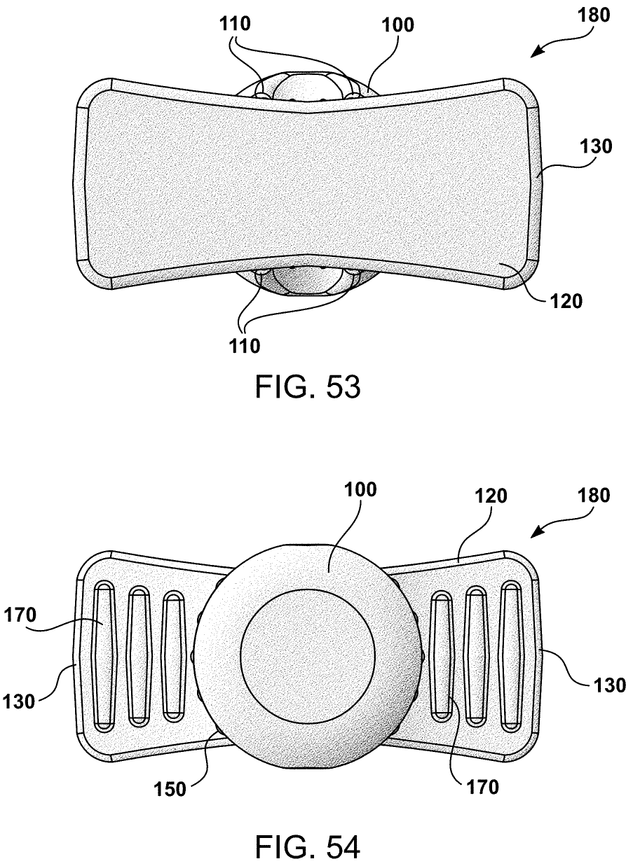

This example establishes working examples for a pet chew toy for dental self-cleaning of the present invention, generally being a “insert” configuration, as exemplified by FIG. 44 through FIG. 54.

As set forth in FIG. 44 through FIG. 54, in this aspect of the present invention the device of FIG. 1 through FIG. 6 has been modified so as to have a more rounded Chewing Member (100) with modified Nub Shaped Elements (110), Bottom Stabilizing Portion (120), Projection (120), Protruding Scrubbing Elements (140), Grooves (150), Aperture (160), Gripping Elements (170), and the Internal Space to reduce materials use (190), Internal Cavity (500), and Dispensing Holes (510), and further a Space for Insert (4400).

In this aspect of the present invention, the device does not have a top aperture, but rather the dispensing hole functions as both aperture to insert materials such as toothpaste, and to dispense such material such as toothpaste.

All publications, including patent documents and scientific articles, referred to in this application and the bibliography and attachments are incorporated by reference in their entirety for all purposes to the same extent as if each individual publication were individually incorporated by reference.

All headings and titles are for the convenience of the reader and should not be used to limit the meaning of the text that follows the heading, unless so specified.

What is claimed is:

1. A chew toy for pet dental hygiene, comprising:
a) at least one chewing member, comprising:
i) at least one groove running in a longitudinal direction of the at least one chewing member that comprises a plurality of protruding scrubbing elements; and
ii) a plurality of nub shaped elements positioned on an outside surface of said chewing member; and
b) at least one bottom stabilizing portion;
i) wherein said at least one bottom stabilizing portion located at a bottom end of the at least one chewing member and being in a perpendicular plane with respect to the at least one chewing member comprises at least one projection that stabilizes said chew toy when in use.

2. The chew toy of claim 1,
wherein said at least one groove is generally U-shaped.

3. The chew toy of claim 1,
wherein at least one of said at least one groove comprises, on at least a portion of all internal surfaces of said at least one groove, a plurality of protruding scrubbing elements.

4. The chew toy of claim 1,
wherein when there are two or more grooves, said two or more grooves are arranged parallel to each other.

5. The chew toy of claim 1,
wherein said at least one groove is perpendicular to an at least one bottom stabilizing portion.

6. The chew toy of claim 1,
wherein said at least one groove is substantially the length of said chewing member.

7. The chew toy of claim 1,
wherein when there are two or more grooves, said two or more grooves are positioned on opposing sides of said chewing member.

8. The chew toy of claim 1,
wherein each said at least one grooves is generally U-shaped in cross section across said chewing member.

9. The chew toy of claim 1,
wherein said at least one groove generally defines said at least one chewing member with a first and second end.

10. The chew toy of claim 1,
wherein said at least one groove is sufficiently deep to clean teeth to the gum line.

11. The chew toy of claim 1,
wherein said protruding scrubbing elements comprise bristles.

12. The chew toy of claim 1,
wherein said nub shaped elements are smaller in diameter than said protruding scrubbing elements, shorter in length than said protruding scrubbing elements, or a combination thereof.

13. The chew toy of claim 1,
wherein said chew toy does not comprise said nub shaped elements.

14. The chew toy of claim 1,
further comprising at least one aperture.

15. The chew toy of claim 1,
further comprising at least one cavity within said chewing member.

16. The chew toy of claim 15,
wherein said at least one cavity is longitudinal as to said at least one chewing member.

17. The chew toy of claim 16,
wherein said at least one cavity begins at an aperture in said first end of said chewing member and runs at least a portion of the length of said chewing member.

18. The chew toy of claim 1,
wherein said at least one longitudinal cavity is configured to hold at least one substance.

19. The chew toy of claim 18,
wherein said substance comprises toothpaste.

20. The chew toy of claim 1,
further comprising at least one dispensing hole.

21. The chew toy of claim 20,
wherein said at least one dispending hole communicates between at least one cavity and said at least one groove.

22. The chew toy of claim 21,
wherein said at least one dispensing hole is perpendicular to said at least one cavity.

23. The chew toy of claim 20,
wherein said at least one dispensing hole is adapted to transfer at least one substance between said at least one longitudinal cavity and said at least two U-shaped grooves.

24. The chew toy of claim 23,
wherein said substance comprises toothpaste.

25. The chew toy of claim 1,
wherein said at least one projection is substantially flat.

26. The chew toy of claim 1,
wherein said at least one projection is perpendicular to said chewing member;

27. The chew toy of claim 1,
wherein said at least one bottom stabilizing portion is configured to stabilize said chew toy in an upright position.

28. The chew toy of claim 1,
further comprising at least one space for at least one insert.

29. The chew toy of claim 1,
wherein said chew toy does not comprise said at least one bottom stabilizing portion.

30. The chew toy of claim 1,
wherein said pet comprises a dog.

31. A method of promoting pet dental hygiene, comprising:
a) providing a pet in need of promotion of dental hygiene;
b) providing a chew toy of claim 1;
c) allowing said pet to engage with said chew toy.
wherein the dental hygiene of said pet is promoted.
